(19) United States
(12) Patent Application Publication
(10) Pub. No.: US 2006/0102024 A1
(43) Pub. Date: May 18, 2006

(54) Method and system for carrying stencil paper and stencil paper roll

(76) Inventors: Kinya Ono, Ibaraki-ken (JP); Kenji Oshima, Ibaraki-ken (JP)

Correspondence Address: Matthew K Ryan;Frommer Lawrence & Haug, 745 Fifth Avenue, New York, NY, 10151, US

(21) Appl. No.: 10/542,301

(22) PCT Filed: Dec. 4, 2003
(86) PCT No.: PCT/JP03/15550

§ 371 Date: Oct. 12, 2005

(30) Foreign Application Priority Data
Jan. 16, 2003 (JP) 2003-7815

(51) Int. Cl. B41C 1/14

(52) U.S. Cl. 101/128.4

(57) ABSTRACT

In a stencil material conveyor system for conveying stencil material unrolled from a stencil material roll, the stretch or the shrinkage of the image on the conveyed stencil material is avoided. The residue of stencil material roll in a stencil material roll (21b) is calculated by a residue calculating means (b 65), by cumulatively subtracting a length of the stencil made from the total length of the stencil material roll stored in a storage means (70) of the stencil material roll (21b). The write pulse motor is rotated at a higher speed as the residue is reduced, thereby controlling the rotational speed of the platen roller (23) to compensate for reduction of the conveying distance due to slip of the platen roller (23) by the back tension applied to the stencil material and to convey the stencil material at a constant conveying speed.

### FIELD OF THE INVENTION

This invention relates to a stencil material conveyor system and a stencil material conveyor method which convey stencil material unrolled from a stencil material roll. This invention further relates to a stencil material roll.

### BACKGROUND OF THE INVENTION

There have been variously proposed stencil printers where print is made by driving, for instance, a thermal head according to image data obtained by reading out an original by, for instance, a scanner to selectively melt and perforate stencil material to make a stencil, winding the stencil around a printing drum, supplying ink inside the printing drum, and transferring the ink to printing papers through the stencil by, for instance, a roller.

In the stencil printers described above, a stencil material roll into which the stencil material is rolled is employed to improve the operability. The stencil material unrolled from the stencil material roll is held by the thermal head and a platen roller opposed to the thermal head, and is conveyed in response to rotation of the platen roller during the stencil making.

When the stencil material is conveyed in response to rotation of the platen roller, the stencil material is applied with a tension in the direction reverse to the direction of conveyance so that the part pinched by the thermal head and the platen roller is not wrinkled. The tension is provided, for instance, by a silicone damper provided in a roll holder by which the stencil material roll is held. The torque required to rotate the silicone damper is constant and the product of the tension generated in the stencil material and the diameter of the stencil material roll balances with the torque.

However, as the stencil material roll is consumed in the stencil making, the diameter of the stencil material roll is reduced and the tension generated in the stencil material increases. When the tension generated in the stencil material becomes large, the stencil material will slip with respect to the platen roller. The slip shortens the distance by which the stencil material is conveyed for the distance by which the platen roller is rotated. That is, the stencil made is shorter than the expected dimension and distortion appears in the image in the stencil made. In order to avoid this problem, there have been proposed, for instance, in Japanese Unexamined Patent Publication Nos. 11(1999)-309833 and 2002-19247 methods where a roller or the like holding constant the tension on the stencil material which changes depending on the diameter of the stencil material roll is provided. These methods are disadvantageous in that they require a mechanism including a roller or the like, which adds the cost of the system and the overall size of the system. Especially, in the part near to the core of the stencil material roll, the methods does not provide a solution to the above-mentioned problem.

It is necessary for the platen roller to bring the stencil material into close contact with the thermal head. Accordingly, the platen roller is provided with an elastic body formed of, for instance, rubber. However, since such an elastic body is expanded or shrunk with change in the working environmental temperature, the diameter of the platen roller changes and, as a result, the conveying speed of the stencil material differs for a given rotational speed of the platen roller, whereby stretch or shrinkage of the image in the stencil made is generated.

When the stencil material comprises thermoplastic film and porous support film laminated together, the conveying speed of the stencil material can be changed depending on the friction coefficient of the surface of the thermoplastic film in contact with the thermal head, and/or the friction coefficient of the surface of the porous support film in contact with the platen roller, and/or the friction coefficient of the surface of the thermal head in contact with the thermoplastic film and the above-mentioned problem arises.

In view of the foregoing observation and description, the primary object of the present invention is to provide a stencil material conveyor method and a stencil material conveyor system which can avoid the stretch or the shrinkage of the image on the stencil made without adding to the overall size of the system or to the cost of the system.

### SUMMARY OF THE INVENTION

In accordance with the present invention, there is provided a stencil material conveyor method of conveying stencil material unrolled from a stencil material roll with the conveyor means caused to work at a predetermined working speed characterized by the steps of obtaining a residue of the stencil material roll, and controlling the working speed of the conveyor means on the basis of the residue obtained to convey the stencil material at a constant speed.

The “conveyor means” may comprise, for instance, a platen roller or a conveyor belt.

The above mentioned “conveying stencil material with the conveyor means caused to work at a predetermined working speed” means, when the conveyor means comprises a platen roller, conveying stencil material with the platen roller rotated at a predetermined rotational speed, whereas when the conveyor means comprises a conveyor belt, conveying stencil material with the conveyor belt moved at a predetermined moving speed.

Further, in order “to obtain a residue”, the residue may be obtained either by the operator of the system directly inputting the residue through a predetermined input means, by measuring the diameter of the stencil material roll and calculating the residue on the basis of the measured diameter of the stencil material roll, or by obtaining in advance the total length of the stencil material in the stencil material roll before use and cumulatively subtracting the consumption of the stencil material to obtain the residue. Further, the residue need not be directly obtained but consumption of the stencil material may be obtained as a value which indirectly represents the residue.

When the conveyor means comprises a platen roller, “Controlling the working speed of the conveyor means on the basis of the residue of the stencil material obtained to convey the stencil material at a constant speed” means, since as the diameter of the stencil material roll is reduced, the above-mentioned tension increases to generate slip, to increase the rotational speed of the platen roller taking into account the slip so that the conveying speed of the stencil material is kept unchanged. Whereas, when the conveyor means comprises a conveyor belt, “Controlling the working speed of the conveyor means on the basis of the residue of the stencil material obtained to convey the stencil material at a constant speed” means, since as the diameter of the stencil material roll is reduced, the above-mentioned tension increases to generate slip as when the conveyor means comprises a platen roller, to increase the moving speed of the conveyor belt taking into account the slip so that the conveying speed of the stencil material is kept unchanged. The above-mentioned “constant” may be substantially constant and the expression “to convey the stencil material at a constant speed” means to suppress change in the conveying speed of the stencil material due to the change in the residue but change in the conveying speed of the stencil material due to other factors.

In the stencil material conveyor method described above, the kind of the stencil material may be obtained and the working speed of the conveyor mean may be controlled on the basis of the kind of the stencil material obtained and the residue to convey the stencil material at a constant speed.

For example, when the stencil material comprises thermoplastic film and porous support film laminated each other, the “kind of the stencil material” may be the kind of the thermoplastic film or the porous support film. Further, the above-mentioned “kind of the stencil material” may be either in information itself representing the kind of the stencil material or in a parameter such as a number or a symbol representing the information and may be of any data so long as it represents the information.

Further, in order “to obtain the kind of the stencil material”, the kind may be obtained either by the operator of the system directly inputting the kind through a predetermined input means or by storing kind data, for instance, in a memory provided in the stencil material roll and reading out the same.

In accordance with the present invention, there is provided a stencil material conveyor system of conveying stencil material unrolled from a stencil material roll with the conveyor means caused to work at a predetermined working speed characterized by a residue obtaining means which obtains a residue of the stencil material, and a working speed controlling means which controls the working speed of the conveyor means on the basis of the residue of the stencil material obtained to convey the stencil material at a constant speed.

The stencil material conveyor system may further comprise a temperature detecting means which detects the working environmental temperature and the working speed controlling means may control the working speed on the basis of the working environmental temperature of the thermal head detected by the temperature detecting means and the residue to convey the stencil material at a constant speed.

The stencil material conveyor system may further comprise a kind obtaining means which obtains the kind of the stencil material and the working speed controlling means may control the working speed on the basis of the kind of the stencil material obtained by the kind obtaining means and the residue to convey the stencil material at a constant speed.

The stencil material conveyor system may further comprise a thermal head which perforates the stencil material and a thermal-head kind obtaining means which obtains the kind of the thermal head and the working speed controlling means may control the working speed on the basis of the kind of the thermal head obtained by the thermal-head kind obtaining means and the residue to convey the stencil material at a constant speed.

Further, in order “to obtain the kind of the thermal head”, the kind may be obtained either by the operator of the system directly inputting the kind through a predetermined input means or by storing kind data, for instance, in a memory provided in the stencil material roll and reading out the same. In accordance with the present invention, there is provided a stencil material roll which is used for carrying out the stencil material conveyor method described above and comprises a storage means which stores residue data according to the residue of the stencil material.

The storage means may store kind data according to the kind of the stencil material.

In accordance with the stencil material conveyor method and the stencil material conveyor system of the present invention, since the residue of the stencil material roll is obtained and the working speed of the conveyor means is controlled on the basis of the residue of the stencil material obtained to convey the stencil material at a constant speed, fluctuation in the conveying speed due to reduction in the diameter of the stencil material roll can be suppressed and the stretch or the shrinkage of the image on the stencil made can be avoided without adding to the overall size of the system or to the cost of the system, whereby printed images high in dimensional accuracy can be obtained.

When the kind of the stencil material is obtained and the working speed of the conveyor means is controlled on the basis of the kind of the stencil material obtained and the residue to convey the stencil material at a constant speed in the stencil material conveyor method and the stencil material conveyor system, the above-mentioned stretch or the shrinkage of the image on the stencil made can be avoided even if a plurality of stencil materials which are different in frictional coefficient or the like are used.

When the working environmental temperature is detected and the working speed of the conveyor means is controlled on the basis of the working environmental temperature detected and the residue to convey the stencil material at a constant speed in the stencil material conveyor method and the stencil material conveyor system, the above-mentioned stretch or the shrinkage of the image on the stencil made due to change of the diameter of the platen roller can be avoided.

Further when the working speed of the conveyor means is controlled on the basis of the kind of the stencil material obtained and the residue to convey the stencil material at a constant speed, the above-mentioned stretch or the shrinkage of the image on the stencil made due to use of a thermal head different in the surface characteristics can be avoided.

In the stencil material roll of the present invention which is provided with a storage means which stores residue data according to the residue of the stencil material, for instance, even when a partly used stencil material roll is installed, a residue of the stencil material in the partly used stencil material roll can be automatically obtained and a residue of the stencil material can be accurately calculated thereafter.

Further, when the storage means stores kind data according to the kind of the stencil material in the stencil material roll of the present invention has, the kind data of the stencil material can be automatically obtained by reading out the same from the storage means.

### BRIEF DESCRIPTION OF THE DRAWINGS

FIG. 1 is a view showing in brief a stencil printer employing a stencil material conveyor system in accordance with an embodiment of the present invention,

FIG. 2 is a block diagram of a part of the stencil printer shown in FIG. 1,

FIG. 3 is a view showing a correction table in the working speed control means of the stencil printer shown in FIG. 1, and

FIGS. 4A to 4C are views showing other correction tables in the working speed control means of the stencil printer shown in FIG. 1.

### PREFERRED EMBODIMENTS OF THE INVENTION

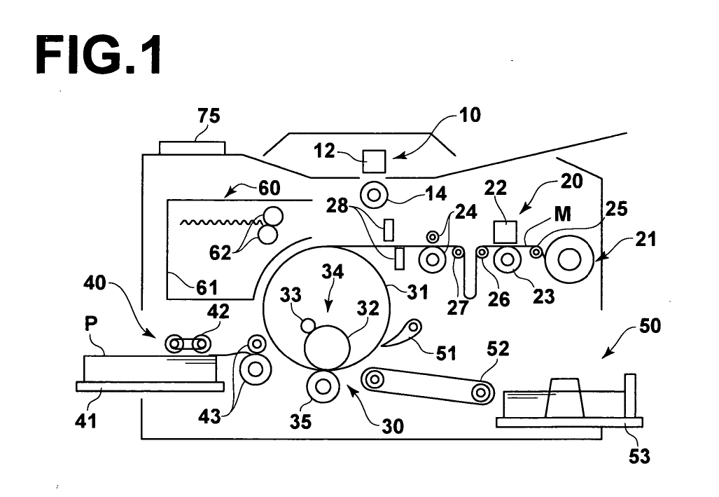

A stencil printer employing a stencil material conveyor system in accordance with an embodiment of the present invention will be described with reference to the drawings, hereinbelow. FIG. 1 is a view showing in brief the stencil printer.

As shown in FIG. 1, the stencil printer comprises a reading portion 10 which reads out an image on an original, a stencil making portion 20 which makes a stencil from stencil material on the basis of the image information read by the reading portion 10, a printing portion 30 which prints on a printing paper by the use of the stencil made by the stencil making portion 20, a paper supply portion 40 which supplies the printing paper to the printing portion 30, a paper discharge portion 50 which discharges the printed printing paper from the printing portion 30, and a stencil discharge portion 60 which discharges the stencil after use.

The image read-out portion 10 is an image scanner and comprises an image line sensor 12 which reads out an image on an original conveyed in a sub-scanning direction, and original feed rollers 14.

The stencil making portion 20 comprises a stencil material roll portion 21, a thermal head 22 where plurality of heater elements are arranged in a row, a platen roller 23, stencil material feed rollers 24, stencil material guide rollers 25, 26 and 27, and a stencil cutter 28. The stencil making portion 20 conveys the stencil material M by, for instance, the platen roller 23 and at the same time, perforates the stencil material M with heat by pressing the stencil material M against the thermal head 22 by the platen roller 23. The platen roller 23 is provided with an elastic body formed of, for instance, rubber to bring the stencil material M into close contact with the thermal head 22.

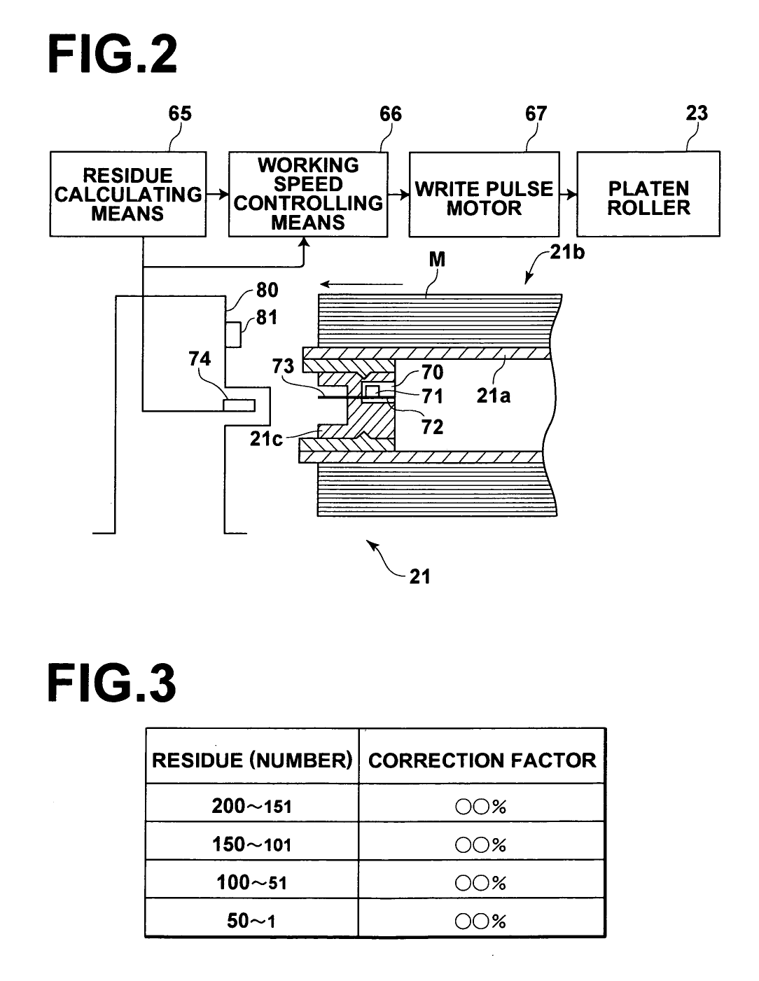

As shown in FIG. 2, in the stencil material roll portion 21, a stencil material roll 21b comprising stencil material M in a continuous length wound around a paper core 21a is mounted on a master holder 80 to be changeable. A storage means 70 which stores, as a length, data on a total length of the stencil material roll 21b before use and the residue of the stencil material M after use of the stencil material roll 21b is disposed in a support member 21c mounted for rotation on one end portion of the paper core 21a of the stencil material roll 21b. The storage means 70 comprises a memory IC 71 forming a non-volatile memory (e.g., an EEPROM) which can hold data for a predetermined time without power supply, and a contact 73 is provided on the tip of a board 72 on which the memory IC 71 is mounted. Further, as shown in FIG. 2, a connector 74 to be electrically connected to the contact 73 of the first storage means 70 of the stencil material roll 21b is disposed in the master holder 80. The master holder 80 is provided with a silicone damper 81 which controls rotation of the paper core 21a so that tension is generated in the stencil material M unrolled from the stencil material roll 21b in the direction reverse to the direction in which the stencil material M is conveyed. Due to the back tension generated in the stencil material M by the silicone damper 81, the stencil material M is suppressed from being wrinkled.

Further, as shown in FIG. 2, the stencil printer of this embodiment is provided with the residue calculating means 65 which calculates the residue of the stencil material roll 21b by cumulatively subtracting the length of the stencil from the total length of the stencil material roll 21b before use each time a stencil is made and a stencil material conveyor means 66 which controls the heating energy to the thermal head 22 on the basis of the stencil material roll residue calculated by the residue calculating means 65, a working speed controlling means 66 which changes the rotational speed of the platen roller 23 by changing the frequency of a write pulse motor 67 (to be described later) on the basis of the residue calculated by the residue calculating means 65, and the write pulse motor 67 which is rotated on the basis of the frequency output from the working speed controlling means 66.

A back tension is generated in the stencil material roll 21b as described above. The back tension increases as the diameter of the stencil material roll 21b reduces. That is, the back tension increases, as the residue of the stencil material roll 21b is reduced. As a result, the stencil material M slips on the platen roller 23 and the conveying speed of the stencil material M is slowed with respect to the timing at which the thermal head 22 generates heat, whereby the image in the stencil made is shrunk. The working speed controlling means 66 controls the rotational speed of the platen roller 23 so that the conveying speed of the stencil material is held constant. Specifically, the working speed controlling means 66 controls the rotational speed of the platen roller 23 to be higher as the residue of the stencil material roll 21b is reduced. A correction table shown in FIG. 3 is stored in the working speed controlling means 66. In the correction table shown in FIG. 3, correction factors are related to the residue of the stencil material roll 21b. The correction factors are determined so that the conveying speed of the stencil material M is kept constant even if the residue of the stencil material roll 21b changes. For example, in the correction table shown in FIG. 3, values such as 10%, 20%, or the like is input as the correction factors. In addition to the correction table, a standard frequency of the write pulse motor 67 which has been set in advance is stored in the working speed controlling means 66. The working speed controlling means 66 obtains the correction factor from the correction table on the basis of the residue data input, adds the value obtained by multiplying the standard frequency by the correction factor to the standard frequency and outputs the result of the addition to the write pulse motor 67. Though, in FIG. 3, the residue is set in terms of the number of stencils which can be further made, the residue may be set in terms of %.

The printing portion 30 comprises a cylindrical ink-transmittable printing drum 31 which is formed of a porous metal plate or a mesh structure, an ink supply system 34 having a squeegee roller 32, and a doctor roller 33 which are disposed inside the printing drum 31, and a press roller 35. The stencil is wound around outer periphery of the printing drum 31.

The paper supply portion 40 comprises a paper supply table 41 on which printing papers P are stacked, a pick-up roller 42 which takes out the printing papers P one by one from the paper supply table 41, and a pair of timing rollers 43 which send a printing paper P between the printing drum 31 and the press roller 35.

The paper discharge portion 50 comprises a separator 51 which peels off printing paper P from the printing drum 31, a paper discharge belt portion 52, and a paper discharge table 53 on which the printed printing papers P are stacked.

The stencil discharge portion 60 comprises a stencil discharge box 61 which is disposed on one side of the printing portion 30 and in which the stencil peeled off the printing drum 31 is placed, and a pair of stencil discharge rollers 62 which peel the stencil off the printing drum 31 after use and convey the stencil peeled off the printing drum 31 into the stencil discharge box 61.

Operation of the stencil printer of this embodiment will be described, hereinbelow.

A stencil material roll 21b is first installed on the master holder 80 and the stencil material M is unrolled from the stencil material roll 21b in a length corresponding to one stencil.

In response to installment of the stencil material roll 21b on the master holder 80, the connector 74 on the master holder 80 is electrically connected to the contact 73 of the storage means 70 provided on the stencil material roll 21b, whereby the total length of the stencil material roll 21b before use which is stored in the first storage means 71 is read out by the residue calculating means 65 and is stored in a memory 66 provided in the residue calculating means 65. Data on a length corresponding to one stencil has been stored in the memory 66, and the residue calculating means 65 calculates the number of stencils which the stencil printer can further make by dividing the total length of the stencil material roll 21b by the length corresponding to one stencil and outputs the number to the working speed controlling means 66. The working speed controlling means 66 obtains the correction factor on the basis of the number of stencils which the stencil printer can further make thus input referring to the correction table. Then the working speed controlling means 66 outputs to the write pulse motor 67 a frequency calculated on the basis of the correction factor obtained. The write pulse motor 67 rotates on the basis of the frequency thus input to rotate the platen roller 23.

The stencil material M brought between the platen roller 23 and the thermal head 22 is pressed against the thermal head 22 by the platen roller 23 and at the same time conveyed by the platen roller 23 whose rotational speed is controlled as described above. The stencil material M thus conveyed is heated and perforated by the thermal head 22, and thereafter conveyed to the stencil cutter 28 by the stencil material feed rollers 24, stencil material guide rollers 26 and 27 and cut by the stencil cutter 28 in a length corresponding to one stencil length. Then the stencil thus made is wound around the printing drum 31.

Ink in a predetermined color is supplied inside the printing drum 31 by the ink supply system 34. As the printing drum 31 is rotated in the counterclockwise direction as seen in FIG. 1, a printing paper P is moved left to right as seen in FIG. 1 by the timing rollers 43 to be supplied between the printing drum 31 and the press roller 35 at a predetermined timing in synchronization with the rotation of the printing drum 31. The printing paper P is subsequently pressed by the press roller 35 against the stencil on the outer peripheral surface of the printing drum 31, whereby the printing paper P is printed with the ink in the predetermined color.

Together with the stencil making action and the printing action described above, the length of the stencil which has been stored in the memory 66 is subtracted from the total length of the stencil material roll 21b before use which has been stored in the memory 66 in the residue calculating means 65 and the value obtained is stored again in the memory 66 as the residue of the stencil material roll 21b. The residue of the stencil material roll 21b stored in the memory 66 is stored in the storage means 70 by way of the connector 74 and the contact 73. When the stencil making action is to be performed next, the residue calculating means 65 reads out the residue of the stencil material roll 21b which has been stored in the storage means 70 to calculate the number of stencils which can be further made in the same manner as described above, and output the number to the working speed controlling means 66. The working speed controlling means 66 obtains the correction factor on the basis of the number of the stencils input thereinto referring to the correction table in the manner described above, and the rotational speed of the platen roller 23 is controlled on the basis of the correction factor during the next stencil making.

By repeating the action described above, the rotational speed of the platen roller 23 is controlled according to the residue of the stencil material M, that is, the platen roller 23 is rotated at a rotational speed according to the diameter of the stencil material roll 21b, and the stencil material M is conveyed at a constant speed.

In the above-mentioned stencil printer, since the residue of the stencil material M in the stencil material roll 21b is obtained and the working speed of the conveyor means is controlled on the basis of the calculated residue, the conveying speed of the stencil material is held constant, whereby the stretch or the shrinkage of the image on the stencil made can be avoided, and images high in dimensional accuracy can be printed without adding to the overall size of the system or to the cost of the system.

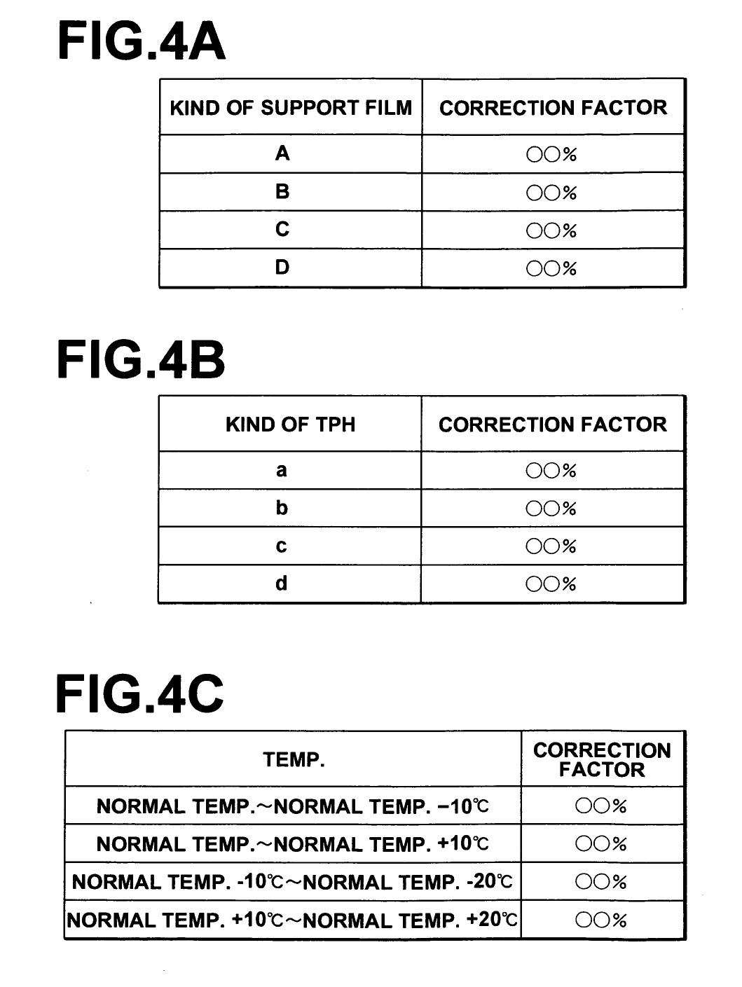

The stencil material M is conveyed by the platen roller 23 as described above. The conveying speed of the stencil material M can be changed depending on the friction coefficient of the surface of the stencil material M in contact with the platen roller 23 and/or the modulus of the stencil material M. Accordingly, it is possible to further provide a stencil material kind obtaining means which obtains the kind of the stencil material M and to provide the working speed controlling means 66 with a correction table such as shown in FIG. 4A whereby, the platen roller 23 is rotated at a rotational speed determined on the basis of the correction factor obtained according to the correction table such as shown in FIG. 4A on the basis of the kind of the stencil material M obtained by the stencil material kind obtaining means so that the conveying speed is kept unchanged. Specifically, since as the modulus of the stencil material M increases, the stencil material M is brought into closer contact with the platen roller 23 and the slip of the stencil material M on the surface of the platen roller 23 becomes less, for instance, when the stencil material M higher in modulus than the standard stencil material M which has been used for obtaining the standard frequency of the write pulse motor and the correction factor employed in the embodiment described above is used, the correction factors are set smaller than 100% whereas when the stencil material M lower in modulus than the standard stencil material M is used, the correction factors are set larger than 100%. Further, since as the friction coefficient of the stencil material M increases, the stencil material M is brought into closer contact with the platen roller 23 and the slip of the stencil material M on the surface of the platen roller 23 becomes less, for instance, when the stencil material M larger in friction coefficient than the standard stencil material M which has been used for obtaining the standard frequency of the write pulse motor and the correction factor employed in the embodiment described above is used, the correction factors are set smaller than 100% whereas when the stencil material M smaller in friction coefficient than the standard stencil material M is used, the correction factors are set larger than 100%. The frequency calculated on the basis of the residue of the stencil material roll is multiplied by the correction factor obtained on the basis of the kind of the stencil material M and the corrected frequency thus obtained is output from the working speed controlling means 66 to the write pulse motor 67 to control the rotational speed of the platen roller 23. In the correction table, it is not necessary to relate the kind of the support film to the correction factor but the kind of the thermoplastic film may be related to the correction factor. Further, parameters native to the kinds of the stencil material which can affect the friction between the stencil material and the thermal head or between the stencil material and the conveyor means such as the platen roller, e.g., the modulus of the thermoplastic film, the porous support film or the stencil material, may be obtained to calculate the correction factor on the basis of the parameter according to a formula.

Further, the conveying speed of the stencil material M can be changed depending on the surface of the thermal head 22 in contact with the stencil material M. Accordingly, it is possible to further provide a thermal head kind obtaining means which obtains the kind of the thermal head 22 and to provide the working speed controlling means 66 with a correction table such as shown in FIG. 4B whereby, the platen roller 23 is rotated at a rotational speed determined on the basis of the correction factor obtained according to the correction table such shown in FIG. 4B on the basis of the kind of the thermal head 22 obtained by the thermal head kind obtaining means so that the conveying speed is kept unchanged. Specifically, since as the friction coefficient of the thermal head 22 increases, the stencil material M is brought into closer contact with the platen roller 23 and the slip of the stencil material M on the surface of the platen roller 23 becomes less, for instance, when the thermal head 22 larger in friction coefficient than the standard thermal head 22 which has been used for obtaining the standard frequency of the write pulse motor and the correction factor employed in the embodiment described above is used, the correction factors are set smaller than 100% whereas when the thermal head 22 smaller in friction coefficient than the standard thermal head is used, the correction factors are set larger than 100%. The frequency calculated on the basis of the residue of the stencil material roll is multiplied by the correction factor obtained on the basis of the kind of the thermal head 22 and the corrected frequency thus obtained is output from the working speed controlling means 66 to the write pulse motor 67 to control the rotational speed of the platen roller 23. In the correction table, the kind of the thermal head 22 may be any so long as it represents the difference of the surface characteristics of the thermal head. For example, the kind of the thermal head 22 may represent the kind of the material of the thermal head or the kind of the protective material coated on the surface of the thermal head. Further, parameters such as the friction coefficient and the surface smoothness of the surface of the thermal head in contact with the stencil material may be obtained to calculate the correction factor on the basis of the parameter according to a formula.

Further, since the elastic body on the platen roller 23 is expanded or shrunk with change in the working environmental temperature, the diameter of the platen roller 23 changes and, as a result, the conveying speed of the stencil material M can change with change of the diameter of the platen roller 23. Accordingly, it is possible to further provide a temperature detecting means which, for instance, detects the working environmental temperature and to provide the working speed controlling means 66 with a correction table such as shown in FIG. 4C whereby, the platen roller 23 is rotated at a rotational speed determined on the basis of the correction factor obtained according to the correction table such shown in FIG. 4C on the basis of the temperature detected by the temperature detecting means so that the conveying speed is kept unchanged. Specifically, since as the working environmental temperature increases, the diameter of the platen roller 23 increases and the conveying speed of the stencil material M is increases, the correction factor is set to be smaller as the working environmental temperature increases. For example, when the standard frequency of the write pulse motor and the correction factor employed in the embodiment described above are empirically obtained under the normal temperature, the correction factors are set equal to 100% when the working environmental temperature is in the range of the normal temperature to the normal temperature −10° C. and the range of the normal temperature to the normal temperature +10° C. in the correction table shown in FIG. 4C, more than 100% when the working environmental temperature is in the range of the normal temperature −10° C. to the normal temperature −20° C., and less than 100% when the working environmental temperature is in the range of the normal temperature +10° C. to the normal temperature +20° C. The frequency calculated on the basis of the residue of the stencil material roll 21b is multiplied by the correction factor obtained on the basis of the working environmental temperature and the corrected frequency thus obtained is output from the working speed controlling means 66 to the write pulse motor 67 to control the rotational speed of the platen roller 23.

The conveying speed of the stencil material M changes also depending on the width of the stencil material M (length in the direction transverse to the direction of conveyance of the stencil material M). Accordingly, the correction factor may be changed according to the width of the stencil material M. Specifically, since as the width of the stencil material M increases, the slip of the stencil material M on the surface of the platen roller 23 becomes more, the correction factors are set larger as the width of the stencil material M increases.

1-8. (canceled)

9. A stencil material conveyor system of conveying stencil material unrolled from a stencil material roll with the conveyor means caused to work at a predetermined working speed characterized by
a residue obtaining means which obtains a residue of the stencil material roll, and
a working speed controlling means which controls the working speed of the conveyor means on the basis of the residue obtained to convey the stencil material at a constant speed.

10. A stencil material conveyor system as defined in claim 9 further comprising a temperature detecting means which detects the working environmental temperature, wherein
the working speed controlling means controls the working speed on the basis of the working environmental temperature of the thermal head detected by the temperature detecting means and the residue to convey the stencil material at a constant speed.

11. A stencil material conveyor system as defined in claim 9 further comprising a stencil material kind obtaining means which obtains the kind of the stencil material, wherein
the working speed controlling means controls the working speed on the basis of the kind of the stencil material obtained by the stencil material kind obtaining means and the residue to convey the stencil material at a constant speed.

12. A stencil material conveyor system as defined in claim 11 in which the kind of the stencil material is expressed on the basis of the kind of the thermoplastic film and/or the porous support film forming the stencil material.

13. A stencil material conveyor system as defined in claim 9 further comprising a thermal head which perforates the stencil material and a thermal-head kind obtaining means which obtains the kind of the thermal head, wherein
the working speed controlling means controls the working speed on the basis of the kind of the thermal head obtained by the thermal-head kind obtaining means and the residue to convey the stencil material at a constant speed.

14. A stencil material conveyor system as defined in claim 13 in which the kind of the thermal head is expressed on the basis of at least one of the kind of the material of the thermal head, the kind of the protective material coated on the surface of the thermal head, the friction coefficient of the thermal head and the smoothness of the thermal head.

15. A stencil material roll used for carrying out the stencil material conveyor method for conveying the stencil material unrolled from a stencil material roll by causing a conveyor means to work at a predetermined speed where a residue of the stencil material is obtained and the working speed of the conveyor means is controlled on the basis of the residue obtained to convey the stencil material at a constant speed, comprising a storage means which stores residue data according to the residue of the stencil material.

16. A stencil material roll used for carrying out the stencil material conveyor method for conveying the stencil material unrolled from a stencil material roll by causing a conveyor means to work at a predetermined speed where kind of the stencil material is obtained as well as a residue of the stencil material roll and the working speed of the conveyor means is controlled on the basis of the kind of the stencil material and the residue to convey the stencil material at a constant speed, comprising a storage means which stores kind data according to the kind of the stencil material.

17. A stencil material roll as defined in claim 16 in which the kind of the stencil material is expressed on the basis of the kind of the thermoplastic film and/or the porous support film forming the stencil material.
